(19) United States
(12) Patent Application Publication
(10) Pub. No.: US 2015/0048621 A1
(43) Pub. Date: Feb. 19, 2015

(54) KITE POWER SYSTEM

(71) Applicant: E-KITE HOLDING B.V., Barneveld (NL)

(72) Inventors: Coenraad, Louis Smeenk, Utrecht (NL); Alfred Van Den Brink, Barneveld (NL)

(73) Assignee: E-KITE HOLDING B.V., Barneveld (NL)

(21) Appl. No.: 14/388,402

(22) PCT Filed: Mar. 27, 2013
(86) PCT No.: PCT/NL2013/050225

§ 371 Date: Sep. 26, 2014

(30) Foreign Application Priority Data
Mar. 27, 2012 (NL) 2008547
Mar. 27, 2012 (NL) 2008549
Sep. 13, 2012 (NL) 2009454
Sep. 13, 2012 (NL) 2009457

(51) Int. Cl. F03D 9/00; B65H 75/44; F03D 5/00; B64C 31/06

(52) U.S. Cl. CPC F03D 9/002; B64C 31/06; B65H 75/4481; F03D 5/00
USPC 290/55

(57) ABSTRACT

A kite power system includes a ground control unit with a generator (30), and a kite connected to the generator (30) via at least two main traction cables (10, 11). A rotor part (31) of the generator (30) includes a winch pulley (32, 33) for each of the at least two main traction cables (10, 11), and each of the winch pulleys (32, 33) is indirectly mechanically connected to the generator (30). A further aspect relates to a kite for use in a kite power generation system, having an airfoil shaped body (20) with one or more air filling apertures (23) in a leading edge part of the airfoil shaped body (20). At least two main traction cables (10, 11) are connected to the airfoil shaped body (20), which further includes an additional filling aperture (21) in a side part of the airfoil shaped body (20).

### FIELD OF THE INVENTION

The present invention relates to a kite power system comprising a ground control unit with a generator, and a kite connected to the generator via at least two main traction cables.

### PRIOR ART

Such a system is known from publications, such as International patent publications WO 2007/122650 and WO 2007/135701, and American patent publications US 2002/040948 and US2007/0126241.

WO2007/122650 discloses an Aeolian system using power wing profiles for generating electrical energy. A wing profile in the form of a kite is controlled to perform a predetermined flight profile, and the force generated by the wind is transferred via two ropes to a basic platform. The basic platform comprises two separate winches and a generator coupled to each winch, as well as a guiding module for neatly winding the rope on the winch.

WO2007/135701 discloses an automatic control system for operation of a kite for harvesting wind energy. The flight trajectory of the kite is controlled using two driving cables and controlling two winches on which the cables are wound. Control is implemented to optimize the amount of kinetic energy subtracted from the wind.

US2002/040948 discloses an axial mode linear wind turbine. Multiple airfoil kites are attached in tandem to a pivotal control housing via two control lines and two support lines. Using the two control lines, the multiple airfoil kites are controlled to make a predetermined trajectory including a power stroke and a rewind section.

US2007/0126241 discloses a wind drive apparatus for an aerial wind power generation system. A first tow line wraps around a first reel and a second tow line wraps around a second reel. The first reel is fixedly attached to a shaft which is connected to a generator, and the second reel is rotatably attached to the same shaft. The mutual rotational position of the first and second reel can be adjusted using a toothed gear and control motors, attached to a drum part of the second reel.

Furthermore, wind power generation systems are known from further prior art publications, such as International patent publications WO2009/026939 and American patent publication U.S. Pat. No. 7,287,481 and US 2011/0272527.

WO 2009/026939 discloses an aerodynamic wind propulsion device, particularly for watercraft. A guiding line is connected between the aerodynamic wing and a pole at the base platform and used to guide the aerodynamic wing during the starting and landing maneuvers by transferring a tensile force.

U.S. Pat. No. 7,287,481 discloses a launch and retrieval arrangement for a kite in particular for driving watercraft. A plurality of reefing lines is used to reduce or increase the size of the aerodynamic profile element and to provide a tensile force between a mast on a watercraft and the aerodynamic profile element during starting and landing maneuvers.

US 2011/0272527 discloses a power generating kite system. The system includes an additional reefing cable and hydraulic telescoping pole that assists in launching and retrieving the kite. A yaw system is used to turn the kite system at an appropriate angle to increase energy production.

### SUMMARY OF THE INVENTION

The present invention seeks to provide further improvements in kite power systems seeking better efficiency and reliability of the entire system or parts thereof.

According to an aspect of the present invention, a kite power system is provided comprising a ground control unit with a generator, and a kite connected to the generator via at least two main traction cables, wherein a rotor part of the generator comprises a winch pulley for each of the at least two main traction cables, and wherein each of the winch pulleys is indirectly mechanically connected to the generator. This provides for a better and more reliable control of the kite power system, especially in respect of controlling the flight trajectory of the kite.

In a further embodiment, each of the winch pulleys is rotatably connected to the rotor part, and are mutually connected by means of a differential gear, the differential gear having a housing and output axes, the housing being connected to the rotor part and the output axes being connected to the respective winch pulleys. A differential gear will automatically ensure a proper mutual change of the main traction cables connected to the winch pulleys, allowing efficient and reliable control of the kite flight trajectory

In an exemplary embodiment, a relative rotational position of the winch pulleys relative to the rotor part can be set by means of a setting unit having a hydraulic or electric powered actuator, the hydraulic or electric powered actuator being positioned between the rotor part and one of the output axes connected to the winch pulleys, or between the rotor part and one of a plurality of satellite wheels in the differential gear. Alternatively, a relative rotational position of the winch pulleys relative to the rotor part can be set by a braking action on one of the winch pulleys, or on a drive shaft connected thereto, using a braking unit with a hydraulic or electric powered actuator.

In a second aspect, the present invention relates to a kite power system as defined above, wherein a rotor part of the generator comprises a winch pulley for each of the at least two main traction cables, and wherein the winch pulleys are positioned co-axial and are provided with a setting unit for adjusting a relative rotational position of the two winch pulleys. The winch pulleys can thus be controlled using the setting unit, both for controlling the flight trajectory of the kite during the energy harvesting phase, and during the rewinding phase. The kite connected to the generator may be a kite as described in one of the embodiment disclosed herein.

In an embodiment, the generator is a direct drive generator. The rotor part may be provided with magnets co-operating with a stator part. Such a direct drive generator eliminates a large number of components found in other kite power generation systems, increasing reliability and reducing disadvantages such as noise production.

One of the winch pulleys is fixedly attached to the rotor part, and the other ones of the winch pulleys are attached to the rotor part in a rotatable manner in a further embodiment, e.g. using a bearing arrangement. Furthermore, the setting unit may be operational in a first range of relative rotational positions during a first condition (operational, energy harvesting), and is operational in a second range of relative rotational positions during a second condition (rewinding phase, reeling in of main traction cables). The second range corresponds to a larger possible length difference between the two main traction cables than the first range. The setting unit may comprise a hydraulically or electrically powered actuator.

In a further embodiment, the setting unit comprises a hydraulically or electrically powered actuator, and is arranged to control a flight trajectory of the kite in the first condition, and to rewind the at least two main traction cables in the second condition.

In an alternative embodiment both winch pulleys are attached to the rotor part in a rotatable manner. Furthermore, both winch pulleys are interconnected by means of a mechanical, hydraulic or electrical differential. The mechanical differential unit comprises a housing which is connected to the rotor part, two sun gears which are internally meshing via satellite gears and are externally connected to the respective winch pulley via a drive shaft, and is arranged to counter rotate and set the relative rotational position of both winch pulleys compared to the rotor part by means of a setting unit. In a further embodiment, the setting unit comprises a hydraulically or electrical powered actuator which can set the relative position of the rotor part compared to one of the drive shafts or compared to one of the satellite gears. The setting unit in this solution only need to overcome the force difference between the main traction cables instead of overcoming the full traction force as required for the earlier mentioned embodiment, thus reducing power consumption, cost and component size. In a further embodiment alternative solutions for the mechanical differential are possible using instead of gears for example a belt, chain or cable. In a further embodiment, the differential function can also be provided by a hydraulic ‘pump to motor’ or electrical ‘motor to generator’ solution.

In a further embodiment an alternative solution for the setting unit is possible by applying a brake force between one of the winch pulleys and the ground. This brake force can be used to set the relative position of both winch pulleys compared to the rotor part when provided at a level sufficient to overcome the force difference between the main traction cables.

In a further aspect, the present invention relates to a kite (or airfoil) for use in a kite power generation system as defined above, further comprising an additional filling aperture in a side part of the airfoil shaped body. This allows to implement the rewinding phase of a kite power system, where a kite is brought back to a starting position, in a much more efficient manner, as the kite can be towed downward with its side facing downward using much less effort than when using the normal streamline profile of the kite.

In a further embodiment, the one or more air filling apertures and the additional filling aperture are provided with one way valves. The one way valves are in a closed position when the local inside pressure is higher than the local outside pressure, which ensures that the airfoil shaped body remains filled with air both in the energy harvesting phase and in the rewinding phase of operation.

The kite further comprises a bridle system in a further embodiment, connecting a plurality of points on the airfoil shaped body to the at least two traction cables, wherein the bridle system provides an airfoil shape to the airfoil shaped body in a first condition, and an air filled airfoil shaped body with a low drag profile in a second condition. A low drag profile in this respect is understood as a shape of the airfoil shaped body with a lower drag coefficient compared to the drag coefficient of the normal operational shape of the airfoil shaped body (e.g. when retracted towards the ground control unit with equal length of the main traction cables). The lines or cables of the bridle system can be arranged to accomplish this effect. In a further embodiment, the bridle system comprises a first part and a second part, the first part being connected to one half of the airfoil shaped body and comprising a first cable guide, and the second part being connected to the other half or the airfoil shaped body and comprising a second cable guide, the first and second cable guide guiding a first cable connected to the airfoil shaped body at both ends of the first cable, and the cable guide being connected to a point on the airfoil shaped body using a second cable. This for example allows to define a proper airfoil shape for normal, energy harvesting operation, and also the low drag profile, which is e.g. a curved form of the airfoil shaped body, such as a banana shape.

In a further embodiment, the kite further comprises a cable guide holding the at least two main traction cables at a fixed distance from each other. This will help in effectively controlling the flight trajectory of the kite, and at the same time securing the shape of the airfoil shaped body during all stages of operation. The cable guide may be attached at a fixed length from the first cable guide of the bridle system, e.g. using a further cable, to ensure appropriate operation.

In a further embodiment, the kite (or cable guide) further comprises sensor electronics, which can be relayed to a ground based station, or which can be used for active control of the kite. Also, the kite (or cable guide) may further comprise an identification unit, such as a light beacon or the like, to make the kite visible for other air operators. The sensor electronics and/or identification unit may be powered using a local power generator, e.g. in the form of an on board power generator (small wind turbine or piezo resonator).

In a further aspect, the ground control unit further comprises a yaw actuator system for controlling a relative azimuth angle of the ground control unit with respect to the at least two main traction cables during operation.

According to this aspect of the invention the traction cable force is directly acting on the cable winch pulley without need for additional main load carrying guiding pulleys. The yaw actuator system allows to position the generator with cable winch pulleys at a defined angle towards traction cables and kite. This solution avoids the need for additional main load carrying guiding pulleys and reduce friction losses and wear from the traction cables. Furthermore this system is used to control the position of the traction cables onto the cable winch pulley during reeling-in.

In a further embodiment, an additional cable guide mechanism with guiding rollers in axial direction of the cable winch pulley, actuation system and positioning sensor can be used, which ensures more accurate and independent positioning for both of the traction cables on the cable winch pulleys of the generator during the reeling-in phase.

The ground control unit further comprises a cable twist control system for the electric power cable connection between rotating ground control unit and static ground, wherein the rotational angle of the ground control unit can be freely adjusted over a wide angle of at least 360 degree. The power cable can be arranged in a ‘spiral shape’ to accomplish this effect.

In a further embodiment, the ground control unit comprises a slip ring assembly for the electrical connections between rotating ground control unit and static ground. This solution eliminates the risk of damaging electrical cables and would allow free-yawing of the ground control unit towards the traction cable(s) and kite. In this case the additional traction cable guiding system must be used to control the position of the traction cable(s) relative to the horizontal axis of the related winch pulleys.

In a further embodiment, the ground control unit comprises means to ensure visibility and identification of the kite power system for air traffic by using a radio transponder, identification lighting and/or other identification or position reporting systems, such as FLARM.

In a second aspect, the present invention relates to a ground control unit as defined above, wherein a system for autonomous launch and retrieval of the kite is provided. In an embodiment it comprises a telescopic arm carrying a kite support frame with guiding opening for the traction cables and wherein the shape of this guiding opening, in combination with a movement of the frame at certain distance from the ground control unit, is used to guide and stabilize the bridle lines and kite during launch and retrieve operation.

In an embodiment, the launch and retrieve system can be directed towards traction cables and kite by rotating the system around the generator horizontal axis.

In a further embodiment, the retrieve operation of the kite is performed by a combination of moving out the launch and retrieve support frame towards the incoming kite and reeling-in the traction cables to such extend that the bridle cables of the kite are pulled through the support opening in the frame and capture/fold both kite bridle line(s) and kite airfoil material tightly to the support frame.

In a further embodiment, a locking mechanism is mounted to the support frame. This solution can clamp the kite bridle line(s) and kite airfoil material to the support frame even when the pulling force from the traction cable is released when moving in the telescopic arm towards park position at ground control unit level.

In a further embodiment, the launch operation of the kite is performed by a combination of moving out the launch and retrieve support frame, unlocking the locking mechanism and reeling-out the traction cables including the bridle cables of the kite thus slowly releasing and unfolding kite bridle line(s) and kite airfoil material through the support opening(s) in the support frame.

In an alternative embodiment, it comprises a telescopic arm carrying a kite support frame that is positioned perpendicular between the traction cables wherein the shape is designed to support the incoming kite around the bottom middle line of the kite during launch and retrieve operation.

In a further embodiment the retrieve operation of the kite is performed by a combination of moving out the launch and retrieve support frame towards the incoming kite and reeling-in the traction cables to such extend that the kite airfoil is supported by the support frame around the bottom middle line of the kite and then pulled tightly around the support frame while further reeling-in the traction cables.

In a further embodiment, it comprises a telescopic arm carrying both a kite support frame with guiding opening for the traction cables and an additional support frame that is positioned perpendicular between the traction cables wherein the shape is designed to support the incoming kite around the bottom middle line of the kite during launch and retrieve operation.

In a further embodiment, the ground control unit is equipped with an air fan. This solution can support the launch operation of the kite by blowing air in the direction of the kite and filling the kite airfoil through the ram air filling inlets. This helps unfolding the kite airfoil and support the release of the kite from the support frame into the air until the wind takes over.

In a third aspect, the present invention relates to a ground control unit as defined above, wherein the direct drive generator construction is using laminations in the stator and/or rotor, not only for electromagnetic flux reasons but also use the laminations as torque transferring housing. In a further embodiment, these laminations are extended with cooling fins.

### SHORT DESCRIPTION OF DRAWINGS

The present invention will be discussed in more detail below, using a number of exemplary embodiments, with reference to the attached drawings, in which

FIG. 1a shows the energy production phase of a kite power system,

FIG. 1b shows the rewinding phase of a kite power system,

FIG. 2a shows the ram air inlets and cable bridle position of the kite in normal flight,

FIG. 2b shows the ram air inlets and cable bridle position in rewinding phase,

FIG. 3a shows the dual pulley system on the rotor of the direct drive generator,

FIG. 3b shows a cross sectional view of a kite power system according to a further embodiment of the present invention,

FIG. 4a shows an embodiment of the kite power generation system using multiple cable guides,

FIG. 4b shows a detailed cross sectional view of a cable guide used in the embodiment of FIG. 4a,

FIG. 5 shows a cross sectional view of a ground control unit according to a first embodiment of the present invention,

FIG. 6 shows a side view of a ground control unit according to a further embodiment of the present invention,

FIG. 7 shows a simplified top view of the ground control unit of FIG. 5 or FIG. 6,

FIG. 8a shows an embodiment of an electric power cable connection by using a spiral cable layout,

FIG. 8b shows a similar embodiment of FIG. 8b at its maximum twist position,

FIGS. 9a-5d shows the retrieve operation of the kite using an embodiment of the ground control unit,

FIGS. 10a-6d shows the launch operation of the kite using an embodiment of the ground control unit,

FIG. 11a shows an embodiment of a calculation method for wind direction and kite position, and

FIG. 11b shows an embodiment of a calculation method for altitude of the kite.

### DETAILED DESCRIPTION OF EXEMPLARY EMBODIMENTS

Generating energy from wind using a kite power system offers advantages over other wind harvesting techniques such as wind turbines, as kite power systems can be produced more economically and are easier to install. Known kite power systems have a disadvantage as the kite needs to be rewound periodically, which requires energy.

The present invention seeks to stabilize and control a kite particularly during the rewinding phase and comprises in various embodiments one or more of the following features: a special kite or airfoil design with extra ram air filling through side inlet(s), one way air valves on all inlets, a cable bridle system under the kite which pulls the kite in a controlled shape, a dual pulley winch system on the generator rotor which allows varying the length of one traction cable against the other for steering the kite in normal flight conditions and pulling the kite on one traction cable during rewinding phase and a direct drive generator for producing the electrical energy.

According to the present invention embodiments improvements are provided in various embodiments of one or more parts of a kite power system:
The kite or airfoil is filled with air during the rewinding phase via extra air inlets which are positioned at the pulling side of the kite maintaining the aerodynamic profile of the kite during this phase and avoid unstable behavior.
Air inlets of the kite are equipped with a one way valve which close when inside pressure in higher than outside pressure. This allows air filling of the airfoil in normal flight condition via the leading edge inlets and filling in rewind condition via the side inlet.
A cable bridle system under the kite, made in such a way that the kite or airfoil is pulled in a pre-defined shape (e.g. a banana shape) during the rewind phase such that aerodynamic drag is minimized while maintaining control.
The two main traction cables are guided together by a cable guide which is attached to the cable bridle system below the kite.
The length of two main connection cables is controlled actively from the dual-pulley winch system on the generator to support steering in normal flight mode, pulling in longitudinal direction of the kite during rewind phase and cable load control during transient conditions between phases to avoid uncontrolled rotating of the kite.
A dual pulley winch system is integrated with the generator rotor such that one pulley is fixed to the rotor and the other pulley can rotate against the rotor by an electric actuator.
A direct drive generator is directly driven by the pulleys without use of gearbox to avoid mechanical losses in the driveline and reduce noise.

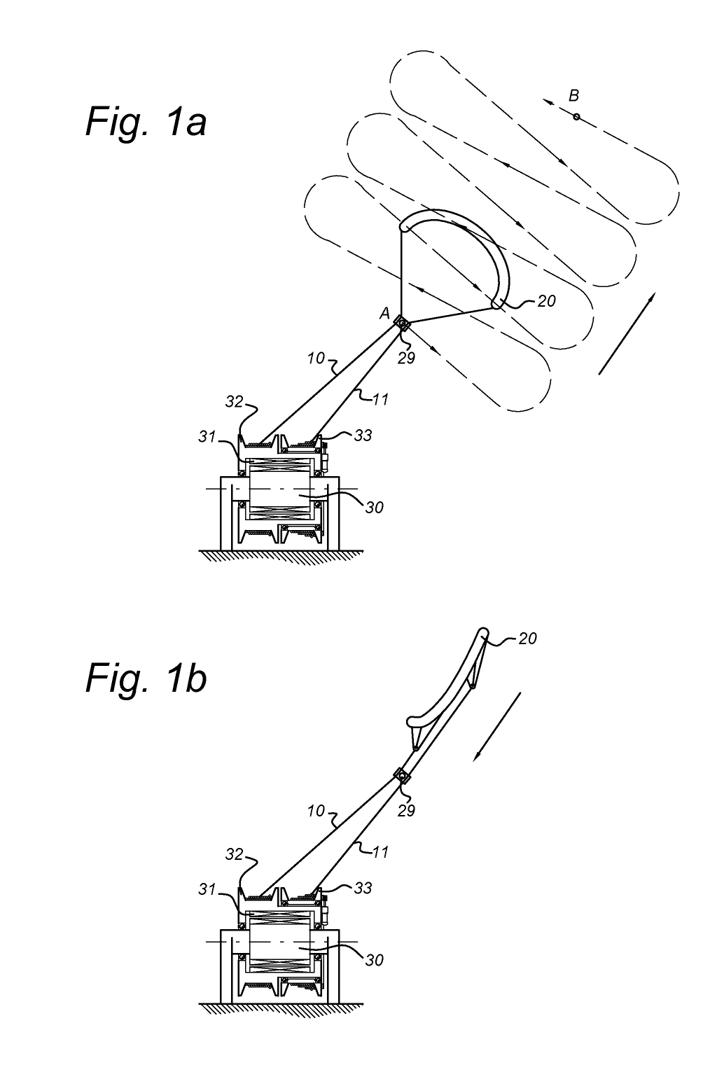

FIGS. 1a and 1b show an exemplary embodiment of a kite power system according to the present invention, comprising an (airborne) kite with an airfoil shaped body 20 connected to a ground-based generator 30 through at least two main traction cables 10 and 11. The ground based generator 30 accommodates two winch pulleys 32 and 33 respectively for each of the at least two main traction cables 10, 11.

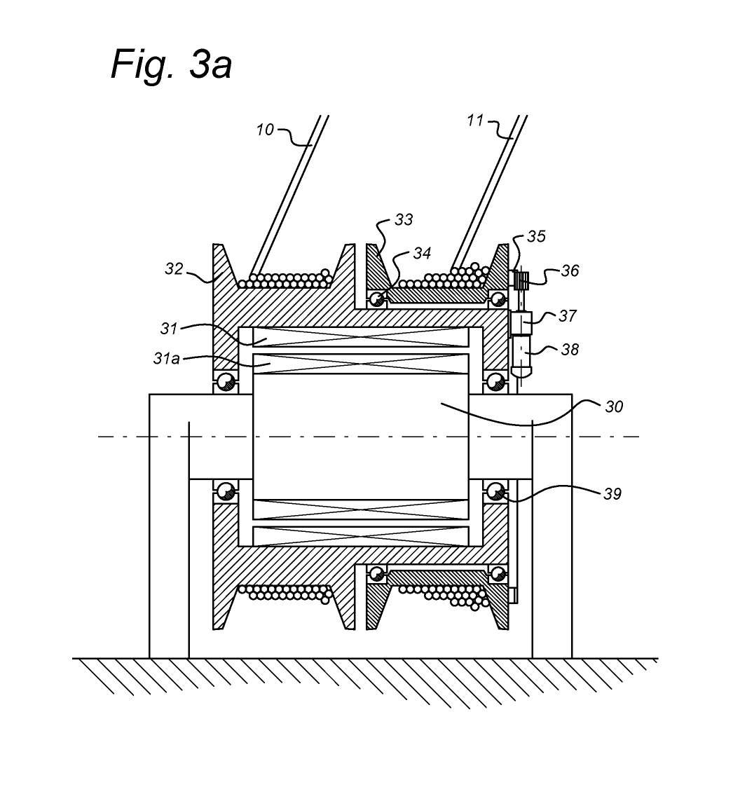

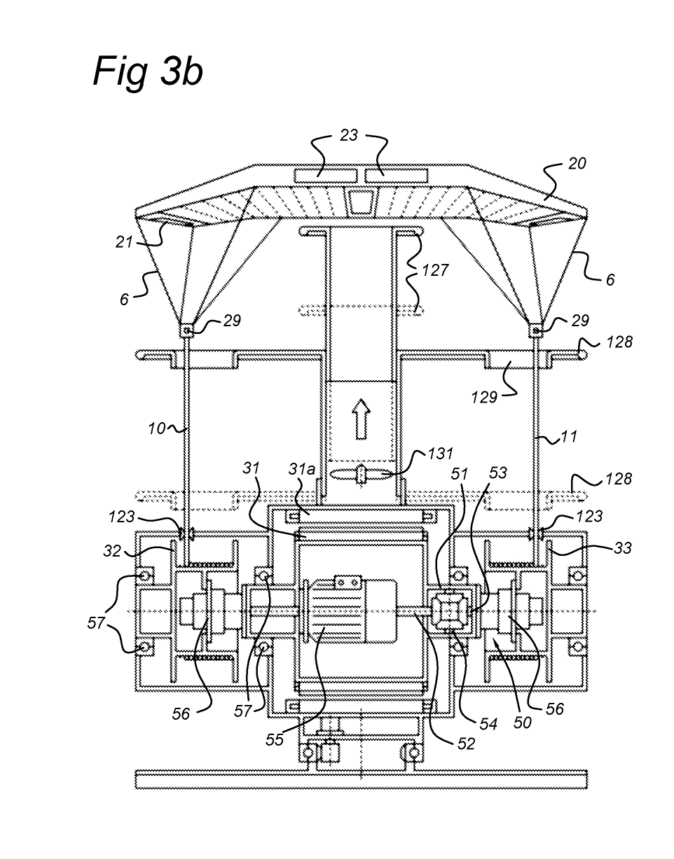

The ground-based generator 30 in this embodiment is a direct drive generator, which is described in more detail with reference to FIG. 3a below. The main traction cables 10 and 11 are held together by a traction cable guide 29 positioned at a predefined distance below the kite 20.

Point A defines a first position of the traction cable guide 29 and point B defines a second position of the traction cable guide 29. The dashed line connecting points A and B defines an exemplary flight path of the traction cable guide 29 and kite 20, where the main traction cables 10, 11 are extending in length in a first, energy harvesting phase indicated by the arrow in FIG. 1a.

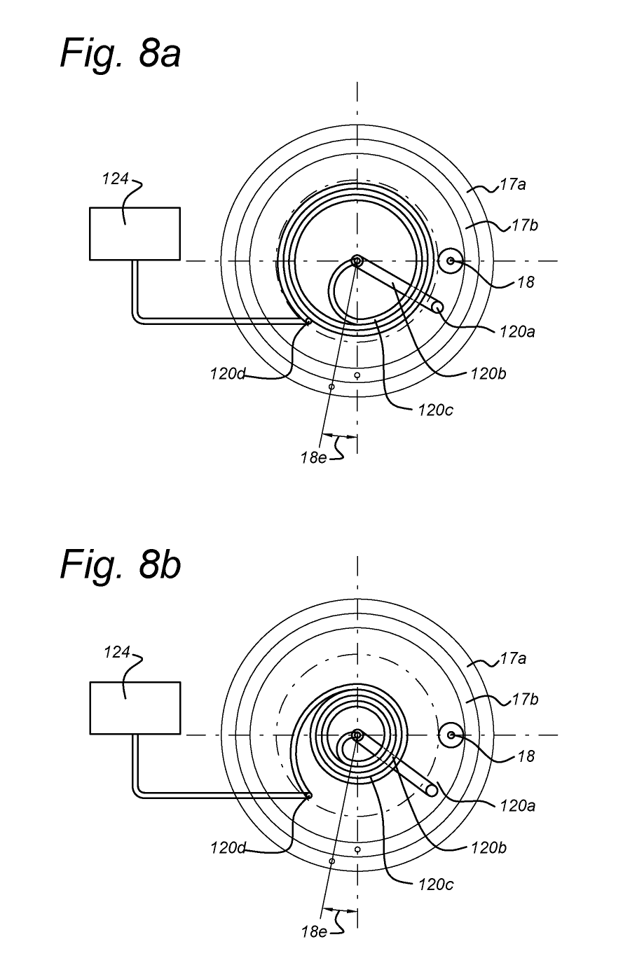

The kite power system is arranged for the production of electric energy by converting traction force and speed from the airborne kite 20 via at least two main traction cables 10 and 11 using a generator 30 on the ground. Steering of the kite is done by changing the length of main traction cables 10 and 11 relative to the cable winches 32 and 33 which are connected to the rotor 31 of the generator 30. From its starting position A the kite 20 follows a sequence of flight positions (e.g. the ‘FIG. 8 pattern’ indicated in FIG. 1a) to generate and transfer a combination of forward speed, traction force and outbound speed towards the generator traction cables 10 and 11. The energy production phase ends when the cable 10 and 11 reach their maximum defined length and the kite arrives at point B.

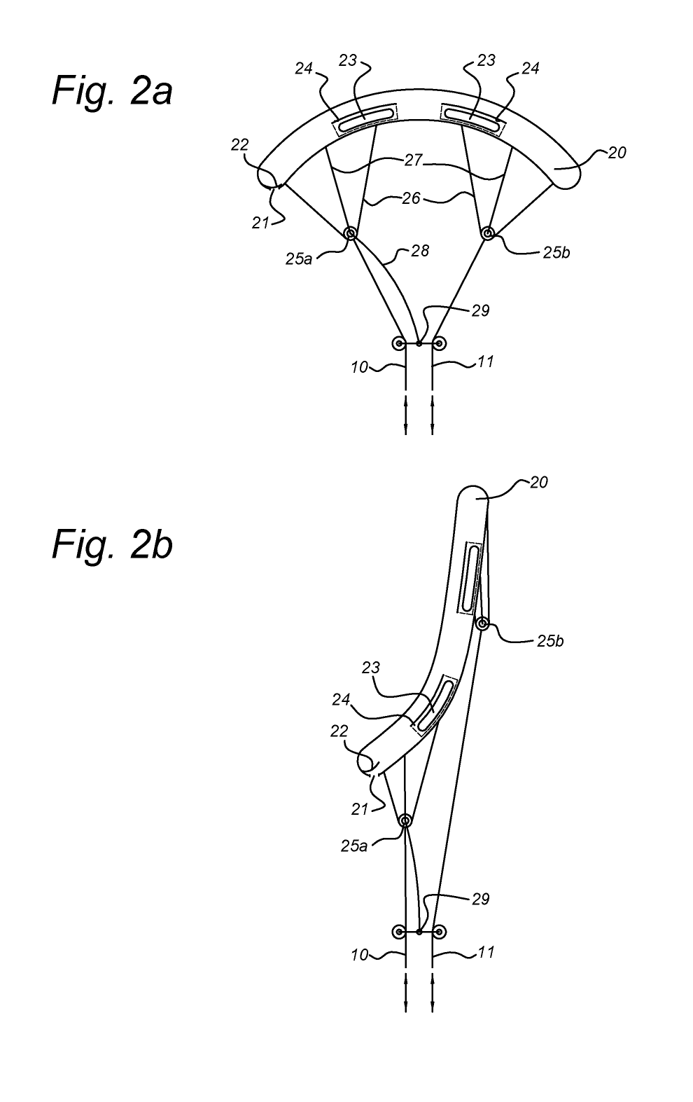

FIG. 1b shows the rewinding phase in which the kite 20 is retracted sideways by pulling the kite 20 at one traction cable 10 back to the starting position A, as indicated by the downward pointing arrow. During this rewinding phase, the kite (airfoil shaped body) 20 remains filled with air via extra air inlets in the side of the kite 20 (see description of FIGS. 2a and 2b below) while being pulled towards the ground such that the kite maintains a predefined (air filled) shape. In this manner the kite aerodynamic resistance is minimized while maintaining good stability and control (also at the transition between rewinding and start of a new energy production cycle).

FIGS. 2a and 2b show an exemplary embodiment of the kite 20 as used in the kite power system of the present invention. The kite 20 is made of a soft material and during operation is filled with air to maintain an aerodynamic airfoil shape.

In the embodiment shown, the kite 20 comprises two ram air inlet openings or air filling apertures 23 positioned in the leading edge of the kite 20, as well as one or more additional ram air inlet openings (additional air filling aperture) 21 at one side of the kite 20. Each ram air inlet opening 23 is equipped with a one-way valve 24 and the additional ram air inlet opening(s) 21 is (are) also equipped with a one-way valve 22. The one-way valves 24, 22 may be embodied as flaps of the same material as the kite 20, e.g. attached on a single line near the respective ram air inlet opening 23, 21. The one-way valve 24, 22 is operational to close off the associated opening 23, 21 when the local pressure inside the kite 20 is higher than the local pressure outside of the kite 20. Whether the one-way valve 24, 22 is open or closed thus depends on the actual attitude of the kite 20 and the actual wind conditions.

The kite 20 is connected to the main traction cables 10 and 11 through a plurality of cables 26 and 27, and a plurality of cable pulleys (or cable guides) 25, forming a bridle system as e.g. known from the field of parachutes and air foils. As shown in a simplified manner in FIGS. 2a and 2b, the bridle system comprises a left part and a right part. Second cable 27 holds the cable pulley 25a, 25b at a fixed distance from the underside of kite 20. First cable 26 is connected to the underside of the kite 20 at both ends, and can freely move through cable pulley 25a, 25b. In an actual implementation, the cables 26 and 27 will be present as a set of cables, which as the entire bridle system, defined the shape of the kite 20 in the wind. The left part cable pulley 25a is connected to the first main traction cable 10, and the right part cable pulley 25b is connected to the second main traction cable 11.

Furthermore, a cable 28 connects the cable pulley 25a to a traction cable guide 29, in order to keep the traction cable guide 29 at a fixed distance below the kite 20. As discussed above with reference to FIGS. 1a and 1b, the main traction cables 10 and 11 run through the traction cable guide 29.

FIG. 2a shows a frontal view of a kite 20 in accordance with an embodiment of the present invention. The kite 20 has in addition to regular ram air inlet opening(s) 23 in the leading edge also one or more additional ram air inlet openings 21 at the side of the kite 20 which is pulled towards the ground during the rewinding phase. In normal flight condition during the energy production phase the airfoil or kite 20 is filled with air via the leading edge ram air inlet openings 23. The air cannot escape through the side inlet since in this condition the one way valve(s) 22 is closed by internal air pressure in order to maintain the aerodynamic profile of the kite 20.

The bridle system as described above with reference to FIG. 2a transfers both forces from the kite 20 to the main traction cables 10, 11 and maintains the aerodynamic shape of the kite 20 in normal flight condition.

As described above, cable 28 is connected between the cable pulley 25a and the traction cable guide 29 which is positioned at certain distance below the kite bridle in order to guide both traction cables 10 and 11 closely together to reduce differences in cable slack and improve steering capabilities of the kite.

FIG. 2b shows a frontal view of a kite 20 during the rewinding phase. At the start of this rewinding phase the second main traction cable 11 is released by the second winch pulley 33 to such extend that the kite 20 can be retracted sideways with a minimum of (or at least lowered) aerodynamic resistance. This can be achieved by pulling the first main traction cable 10 from the first cable winch pulley 32 on the generator 30. The length of cable 11 is controlled by the cable winch pulley 33 during this phase to maintain a controlled shape of the kite airfoil shaped body 20, in combination with the entire bridle system components (cable pulleys 25a, 25b, cables 26, 27, 28 and traction cable guide 29).

The traction cable 10 is connected to the cable pulley 25a and pulls the kite 20 via a plurality of cables 26, 27 and cable pulley 25a into a pre-defined shape such that the airfoil is filled by air through the special ram air inlet(s) 21 and open one way valve(s) 22 in the side of the kite 20. The air inside the kite 20 cannot escape through the leading edge inlets 23 since in this condition the one way valve(s) 24 are closed by internal air pressure in order to maintain the aerodynamic profile of the kite 20.

Towards the end of the rewinding phase the pulling force of the main traction cable 10 will be reduced to a minimum level while the length of the main traction cable 11 is restored by the second cable winch pulley 33 to an equal level compared to the length of traction cable 10 in order to bring the kite 20 back to its normal flight position.

In this normal flight condition the airfoil of the kite 20 is again filled with air via the leading edge ram air inlet openings 23 while the side ram air inlet opening(s) 21 are now closed by the one way valve(s) 22 due to the internal air pressure. The aerodynamic profile of the kite is maintained by the traction cables 10 and 11 though the plurality of cables 26, 27 and cable pulley 25.

In an even further embodiment of the kite 20, additional stability is provided during the rewinding phase using a deployable fin on the side of the kite opposite to the attachment of the second main traction cable 11. The deployable fin is e.g. retracted during most of the time, such as during the normal power generating phase, and is extended during the rewinding phase. This can be aerodynamically controlled, i.e. the fin is extracted automatically when the kite 20 is brought in the controlled shape during the rewinding phase, or it can be actuated or supported using parts of the kite 20, such as the ram air inlet(s) 21 or cables attached to the bridle system. In a specific exemplary embodiment, the deployable fin is connected via the bridle system to the second main traction cable 11, and is arranged to be extracted automatically when the kite 20 is brought in the controlled shape during the rewinding phase. The deployable fin can be actuated by the second main traction cable 11 via the bridle system thus providing steering option to the kite from the ground station in this phase.

FIG. 3a shows a cross-section of an exemplary embodiment of the ground-based generator 30 of the present invention. The ground-based generator 30 comprises a first cable winch pulley 32 arranged to accommodate the first main traction cable 10, and a second cable winch pulley 33 arranged to accommodate the second main traction cable 11. The second cable winch pulley 33 is positioned coaxially to the first cable winch pulley 32.

The ground-based generator 30 in this embodiment is of the direct drive type, where a rotor 31 (e.g. outer rotor in the embodiment of FIG. 3a) is rigidly connected to the first cable winch pulley 32. A stator 31a (e.g. inner stator in the embodiment of FIG. 3a) is part of the ground-based generator 30, and is positioned coaxially to the rotor 31. The first cable winch pulley 32 is attached to the ground-based generator 30 using bearings 39 for rotation around the axis indicated by the dash dot line of FIG. 3a.

The second cable winch pulley 33 is attached to the first cable winch pulley 32 using bearings 34, allowing mutual rotation of the first and second cable winch pulleys 32, 33. The mutual (rotational) position controls the difference in length of the main traction cables 10, 11 needed to control the flight trajectory of the kite 20 both in the energy harvesting phase and in the rewinding phase, as described above.

The mutual position of the first and second cable winch pulleys 32, 33 is controlled with a setting unit, which in the embodiment as shown in FIG. 3a comprises an electric or hydraulic actuator 38. The actuator 38 is fixedly connected to the first cable winch pulley 32 using a holding part 37. The actuation movement of the actuator 38 is translated to a mutual rotation of first and second cable winch pulleys 32, 33, e.g. using a rack and pinion embodiment as shown. A gear 35 which is rigidly connected to a wall of the second cable winch pulley 33 is co-operating with a pinion 36 attached to the actuator 38.

In an alternative embodiment both cable winch pulleys 32, 33 are attached to the rotor part 31 in a rotatable manner, as shown in the cross sectional view of FIG. 3b. The rotor part 31 is attached to the ground-based generator 30 using bearings 57 for rotation around the axis indicated by the dot line of FIG. 3b. The cable winch pulleys 32, 33 are interconnected by means of a mechanical differential 50 comprising a housing 51 which is connected to the rotor part 31, two sun gears which are internally meshing via satellite gears 54 and externally connected to the respective winch pulleys 32, 33 via drive shafts or output axes 52, 53. The mutual position of the first and second cable winch pulleys 32, 33, relative to the rotor part 31, is controlled by the differential 50 and a setting unit. The setting unit comprises an electric or hydraulic actuator which can set the relative position of the rotor part 31 compared to of one of the drive shafts 52, 53 or compared to one of the satellite gears. In the embodiment shown the setting unit is implemented as a motor/brake unit 55. The setting unit in this solution only need to overcome the force difference between the main traction cables 10, 11 instead of overcoming the full traction force as required for the earlier mentioned embodiment. This reduces power consumption, cost and component size. In a further embodiment alternative solutions for the mechanical differential are possible using instead of gears for example a belt, chain or cable. In a further embodiment, the differential function can also be provided by a hydraulic ‘pump to motor’ or electrical ‘motor to generator’ solution. In a further embodiment an alternative solution for the setting unit is possible by applying a brake force between one of the winch pulleys and the ground (e.g. using the motor/brake unit 55). This brake force can be used to set the relative position of both winch pulleys compared to the rotor part when provided at a level sufficient to overcome the force difference between the main traction cables.

In the embodiment shown in FIG. 3b, furthermore, the winch pulleys 32, 33 are rotatably connected to the rotor part 31, each using an additional gearbox 56. This also allows to further optimize the kite power system, in particular the dimensions and capacities of the generator components (such as rotor 31 and stator 31a).

In one embodiment, the stator 31a and/or rotor 31 of the direct drive generator (or at least the active material parts thereof) are made from sheet material joined together, such that the stator 31a and rotor 31 are formed by stacking laminated components. The laminated components form a torque transferring housing and the active material for the rotor 31 and/or stator 31a. The laminated components are sheets of suitable material oriented perpendicular to the rotational axis of the stator 31a and rotor 31. In a further embodiment, the laminated stator 31a and laminated rotor 31 are provided with cooling fins. Using this structure, it is possible to have a very efficient magnetic flux guidance in the rotor and/or stator part of the direct drive generator 30, and it is possible to provide for a very good structural build of the rotor and/or stator part, allowing efficient torque and force transfer. It is noted, that this configuration of the generator could also be used in other kite power generation systems independent from the presence of a kite according to one of the embodiments described above.

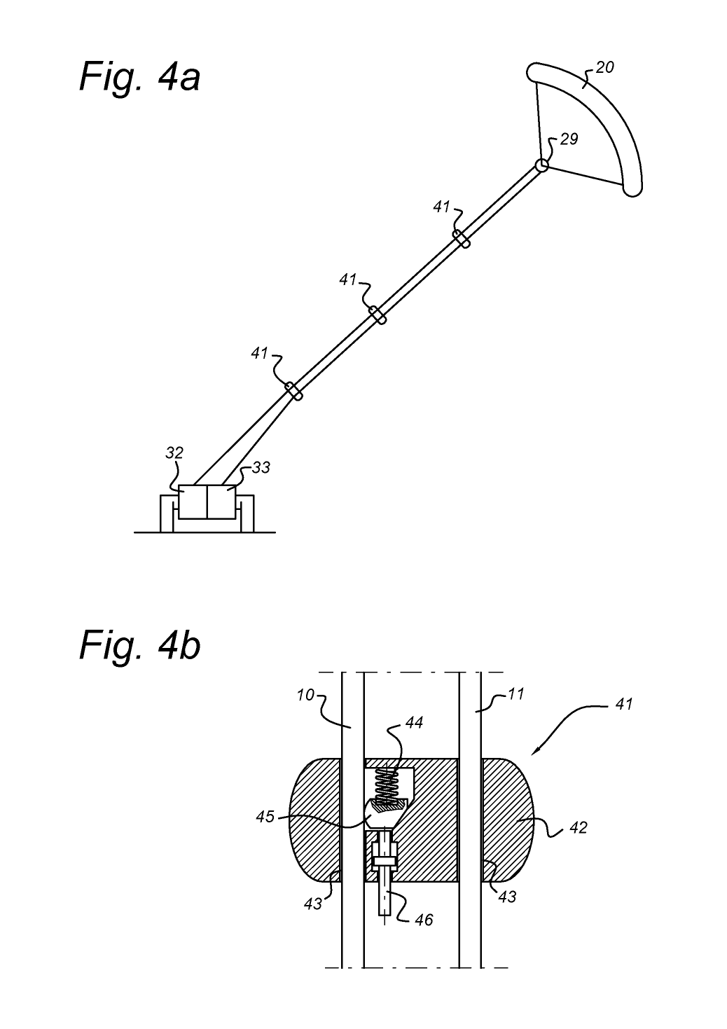

FIG. 4a shows an embodiment of the kite power generation system using multiple cable guides 41, and FIG. 4b shows a detailed cross sectional view of a such a cable guide 41. In this embodiment, the kite further comprises one or more cable guides 41 having a locking mechanism 44-46 operable on one of the main traction cables 10, 11. The one or more cable guides 41 have a main body 42 and two apertures 43 for the main traction cables 10, 11, and are e.g. positioned at regular intervals along the main traction cables 10, 11. The cable guides 41 serve to keep the main traction cables 10, 11 in each other's vicinity, and can optionally also function to increase the visibility of the main traction cables 10, 11 for other air traffic. The cable guides 41 can be released at or near the ground control unit in a controlled manner when the kite 20 is released (i.e. when the main traction cables 10, 11 are veered out.

The main body 42 is provided with a locking mechanism 44-46 operating on one of the main traction cables 10 in operation. The locking mechanism 44-46 e.g. comprises a spring 44 acting on a cable lock 45 in co-operation with a suitable surface in the main body 42. Furthermore a de-lock pin 46 is provided extending on the side of the cable guide facing the ground control unit, and being in contact with the cable lock 45. When the kite 20 is reeled in, the de-lock pin 46 may be actuated with a proper control near the ground control unit (e.g. a lower positioned cable guide 41).

In general, the present invention can be seen as embodied in features relating to the kite 20 part of the system, or as embodied in features relating to the entire kite power system. These embodiments are described in general terms in the claims.

The present invention embodiments are part or parts of a wind power generation system using a kite 20 to harvest wind energy. The kite 20 is controlled to fly a certain pattern, and the force and speed of cables connected to the kite 20 is transformed into electrical energy. In this invention embodiments, the kite 20 used is an airfoil type of kite, which is filled with air in operation and connected with a plurality of bridle cables 6 to give the kite an airfoil shape.

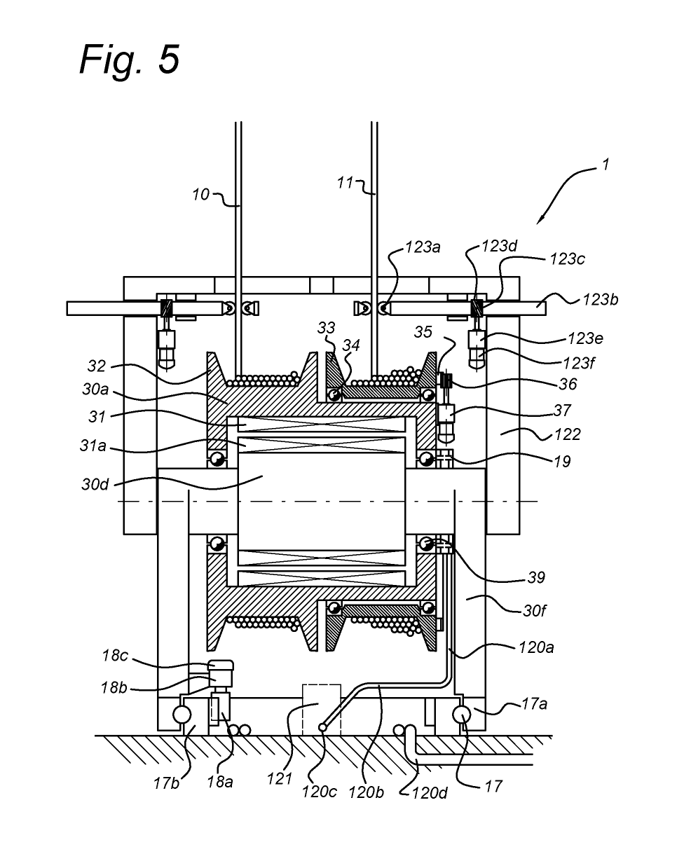

In general, the ground control unit 1 as shown in the embodiment of FIG. 5 can be described as comprising the following components:

a generator 30, wherein a rotor part 30a, 31 of the generator 30 comprises a winch pulley 32, 33 for each of at least two main traction cables 10, 11 connectable to a kite 20, the winch pulleys 32, 33 being positioned co-axial, and wherein the ground control unit 1 further comprises a yaw actuator system 18 for controlling a relative azimuth angle 18e of the ground control unit 1 with respect to the at least two main traction cables 10, 11 during operation.

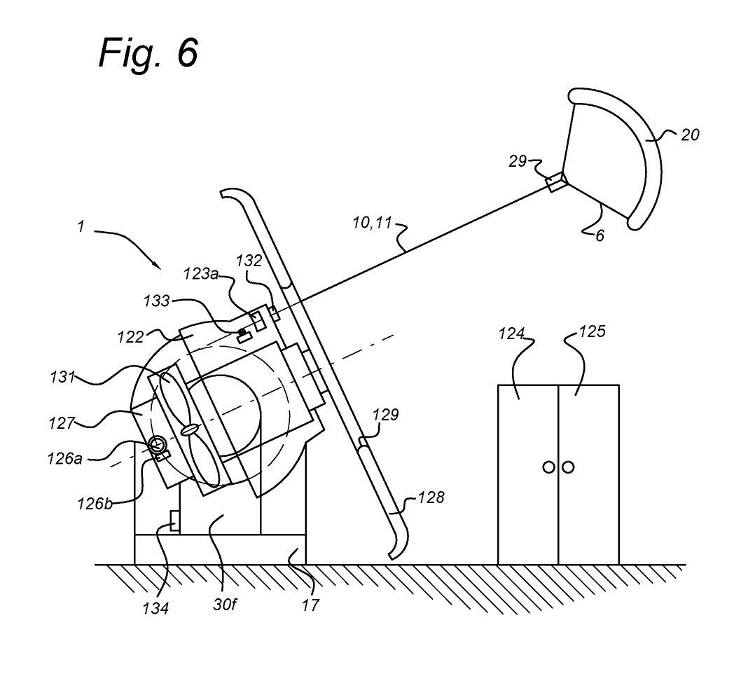

FIG. 5 shows a cross-sectional view of an embodiment of an (autonomous) ground control unit 1 for use in a power generating kite system. Two main traction cables 10, 11 are connected to a kite 20 at a first end (see FIG. 6) and connected to respective cable winch pulleys 32, 33 at a second end. The kite 20 is connected to the traction cables 10, 11 through a plurality of cables 6 called ‘bridle lines’ (in FIG. 6 and other, only two outermost bridle lines 6 are indicated for simplicity).

Cable winch pulleys 32, 33 are part of a rotor part 30a, 31 of a direct drive generator. The rotor part 30a, 31 is rotationally connected to a stator part 31a, 30d of the direct drive generator 30 by means of a bearing 39. Cable winch pulley 32 is rigidly connected to or a part of the rotor part 30a and cable winch pulled 13 is rotationally connected to the cable winch pulley 32 by means of a further bearing 34 and a pulley actuator system. In the embodiment shown the actuator system comprises a hydraulic or electric actuator 37, a pinion 36 and a gear 35 that is rigidly connected to a wall of the cable winch 33. This allows for relative rotation of the cable winch pulley 33 with respect to the other cable winch pulley 32.

The ground control unit 1 is designed to rotate around a vertical axis with respect to the ground by means of a yaw bearing 17, which is rigidly connected to the ground at an inner side 17b of the ground control unit 1. An outer side 17a is rigidly connected to stator 30d through support legs 30f.

A yaw actuator system 18 is designed to rotate the ground control unit 1 around the vertical axis towards a desired azimuth angle with respect to the traction cables 10, 11. The yaw actuator system 18 e.g. comprises a yaw actuator 18c, a yaw actuator gear 18b and a rack and pinion transmission 18a for mutual movement of the outer side 17a and inner side 17b.

The ground control unit 1 is electrically connected to the ground (e.g. to a power conversion system or power electronics 124 external to the ground control unit 1, see description of FIG. 6 below) by means of a cable twist control system 120 or a slip ring assembly 121. In one embodiment, the cable twist control system 120 or slip ring assembly 121 enables to rotate the ground control unit 1 in an azimuth range of more than 360°. In one embodiment the cable twist control system 120 comprises an electrical power cable with segments 120a-120d, of which one is a flexible part 120c allowing for rotational flexibility (e.g. >360°) up to a predefined maximum angle around the vertical axis, by having part of the electrical power cable twist, curl or coil. In another embodiment, the slip ring assembly 121 allows for electrical connection of the generator 30 to the external power conversion system 124, and for complete rotational freedom around the vertical axis, thus avoiding possible damage to electric cables. This is explained in more detail with reference to FIGS. 8a and 8b below.

A rotor slip ring assembly 19 shown in the embodiment of FIG. 5 ensures electrical connectivity between the rotating parts 30a, 31, 31a, 30d of the generator 30, e.g. for excitation of a rotor coil 31 and/or for control of the pulley actuator system 35-37.

The actual steering of the kite 20 is accomplished by individually changing the lengths of the traction cables 10, 11 using the pulley actuator system 35-37, which is configured to rotate the cable winch pulley 33 relative to the cable winch pulley 32.

In one embodiment, the orderly spooling of the traction cables 10, 11 onto the cable winch pulleys 32,33 is accomplished by actively controlling the azimuth angle between the ground control unit 1 and the traction cables 10,11.

Axial movement of the traction cables 10, 11 relative to an outside surface of the cable winch pulleys 32, 33 is accomplished by an optional cable guiding system 123 in a further embodiment, wherein the optional cable guiding system 123 can be used to increase spooling accuracy.

In the embodiment of FIG. 5 elements of the optional cable guide mechanism 123 for each traction cable are shown. The elements comprise a guiding roller 123a for the main traction cable 10, 11, a guiding shaft with spindle 123b, a shaft support 123c, a spindle gear 123d, an actuator gear 123e and actuator motor 123f. When activated the actuator motor 123f rotates the spindle gear 123d resulting in a linear displacement of the spindle shaft 123b, thereby moving the guiding rollers 123a towards a desired position relative to the respective cable winch pulley 32, 33. The elements 123a-123f of the cable guide mechanism can be attached to the ground control unit 1 by a guide frame 122.

In a further embodiment, the unspooling of the traction cables 10, 11 from the cable winch pulleys 32, 33 is controlled using the yaw actuator system 18 in such a manner that the traction cables 10, 11 can run freely so as to minimize friction losses whilst generating electric power. In an alternative embodiment, the optional cable guide mechanism 123 is used to position the main traction cables 10, 11 with respect to the winch pulleys such that the yaw actuator system 18 can be operated in a free mode of operation. The ground control unit is then turned towards the kite during operation by the pulling force on the main traction cables 10, 11 without active use of the yaw actuator system 18.

In yet another embodiment, when a maximum yaw angle around the vertical axis is exceeded, the yaw actuator system 18 controls the yaw angle back into a defined working range to avoid damage of the main traction cables 10, 11.

FIG. 6 shows a side-view of a further embodiment of the ground control unit 1 including a system for launching and retrieving the kite 20. The launch and retrieve system is connected to the cable winch pulleys 32, 33 and in a further embodiment is able to rotate over an elevation angle. This allows to control the position of the launch and retrieve system with respect to the main traction cables 10, 11. In one specific embodiment, an elevation control unit is provided to align the launch and retrieve system in the direction of the traction cables 10,11, e.g. by rotating the support frame 128 relative to the stator 30d. over an elevation angle.

In an actual implementation embodiment, the launch and retrieve system comprises a telescopic arm 127 carrying a kite support frame 128 provided with a guide aperture 129 for each of the main traction cables 10, 11. A hydraulic or electric actuator 126 is configured to change the length of the telescopic arm 127, between an extended position and a retracted position. The telescopic arm 127 is connected on one side to e.g. the outer side 17a of the ground control unit 1.

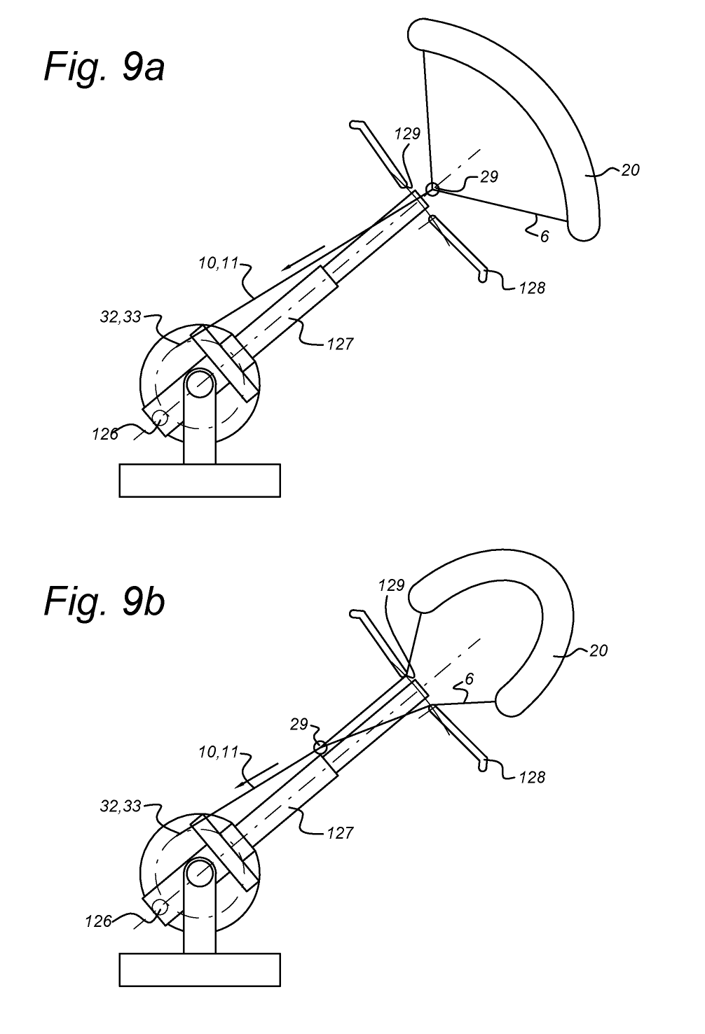

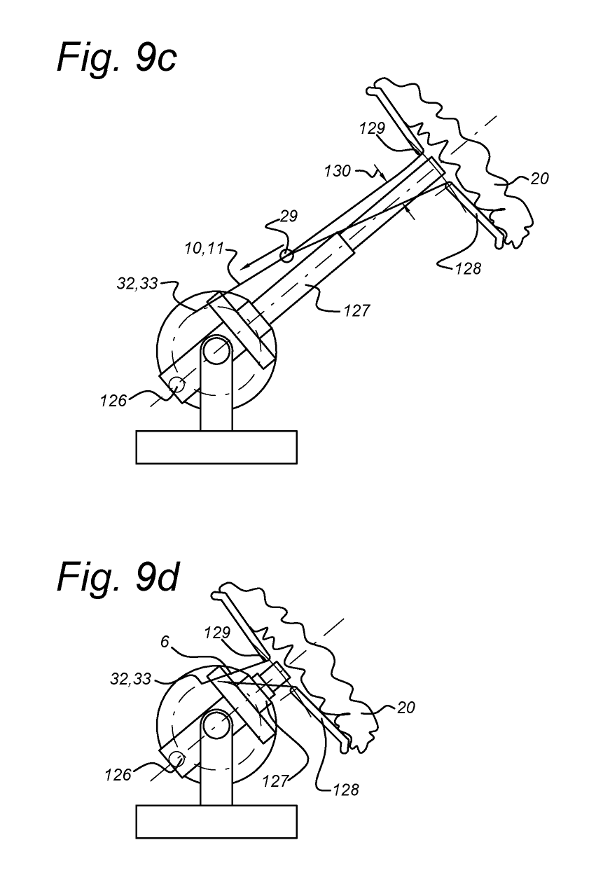

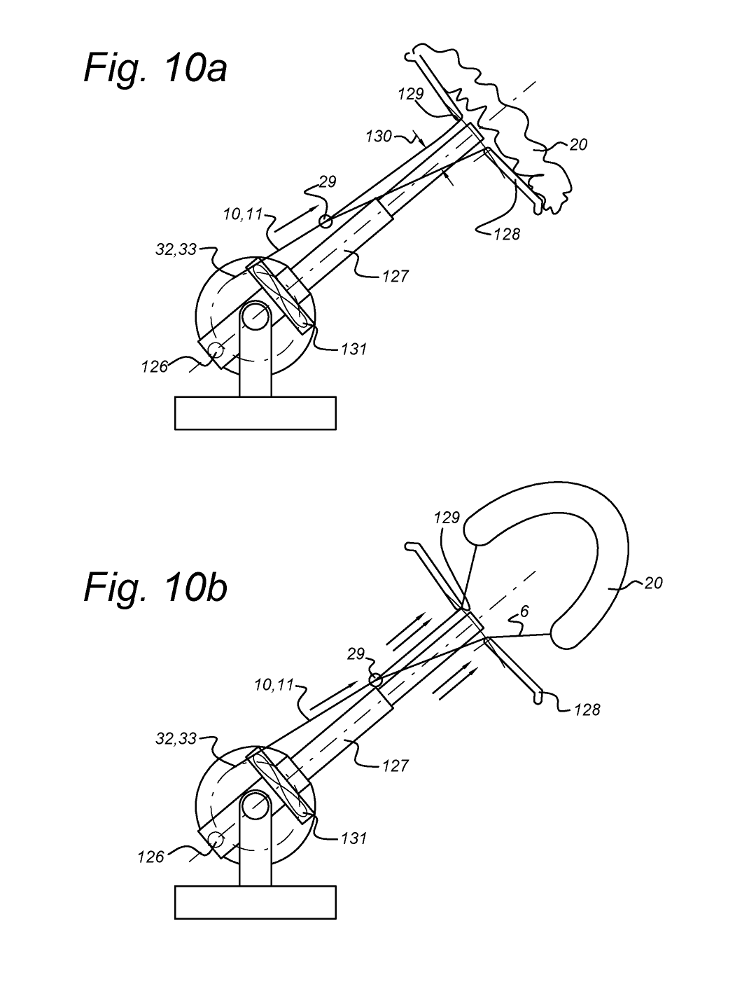

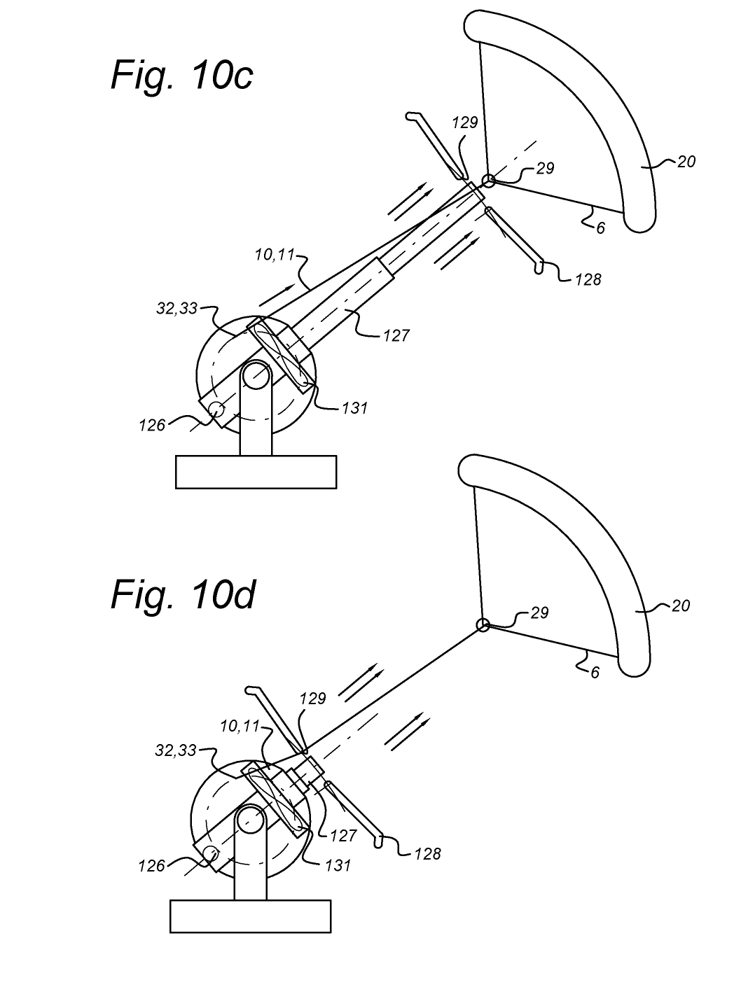

Each of the main traction cables 10, 11 (including bridle lines 6 of the kite 20) is guided through the kite support frame 128. The shape of the kite support frame 128 and guide apertures 129 in combination with telescopic movement of the support frame 128 is used to guide and stabilize the bridle lines 6 and kite 20 during launch and retrieve operation. This is explained in more detail with reference to the drawings of FIG. 9a-9d and FIGS. 10a-10d below. It is noted, that this configuration of the ground control unit could also be used in other kite power generation systems independent from the presence of a yaw actuator system.

In a further embodiment, a radio transponder 132 is positioned on the ground control unit 1 to ensure visibility and to provide identification of the power generating kite system to air traffic in the vicinity of the kite power system. Alternative visibility and/or warning systems may be used in addition to or in combination with the radio transponder 132, such as anti-collision lighting or a FLARM system.

The direct drive generator 30 is connected to power electronics 124 in order to deliver the electrical power to a utility grid. Furthermore, control electronics 125 are present to control the various actuator and sensor systems in the ground control unit 1. In one embodiment, shown in FIG. 6, an electrical cabinet for the power electronics 124 and a cabinet for the control electronics 125 are provided as separate elements, positioned external (at a distance) from the ground control unit 1. In alternative embodiments, the control electronics 125 and/or power electronics 124 are integrated in the ground control unit 1 itself.

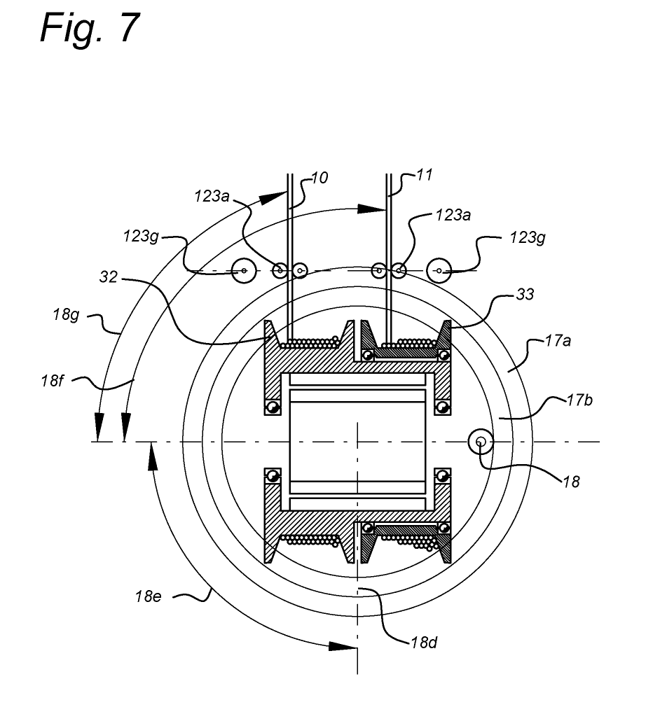

FIG. 7 shows a top view of an embodiment of the ground control unit 1 with the main positioning system characteristics for the spooling of the traction cables 10, 11 onto the cable winch pulleys 32, 33. As mentioned earlier, the cable winch pulleys 32, 33 are connected to the rotor 30a, 31 of the generator 30, which can rotate around a vertical axis with respect to the ground by means of the yaw bearing 17. The yaw actuator system 18 controls a relative azimuth angle 18e between a fixed position 18d on the ground (indicated as dash-dot line in FIG. 7) and an angular position of the ground control unit 1 (indicated by the dash-dot line as axis of the stator part 30d).

The yaw actuator system 18 is furthermore configured to actively control the azimuth angles 18f, 18g between the rotational axis of the cable winch pulleys 32, 33 and the traction cables 10, 11. Angles 18f, 18g are kept at a certain value smaller than 90 degrees in order to spool the traction cables 10,11 in a right-to-left fashion as seen from this top view. Conversely, the traction cables 10,11 spool in a left-to-right fashion when angles 18f, 18g are greater than 90 degrees. The position of the traction cables 10,11 relative to the cable winch pulleys 32, 33 is measured by the position sensors 123g, which monitor the proper spooling of the traction cables 10,11 in order to minimize cable wear and friction losses.

FIG. 8a shows an embodiment of an electric power cable 120 with segments 120a-120c inside the ground control unit 1 at one end and connected to the power electronics 124 via a ground cable 120d at another end. Part of the cable is indicated as a cable arm 120b, and a further part of the cable is indicated as cable spiral 120c. This exemplary embodiment allows for a rotational flexibility around the vertical axis without damaging the power cable 120a, even for azimuth angle movements of the ground control unit 1 over more than 360°. At a starting angle 18e close to zero, the cable spiral 120c is tightly wound against an outer radius measured from the centre point of rotation. When the yaw actuator system 18 is activated, the ground control unit 1 turns with a twist angle 18e. At the same time the cable arm 120b causes the power cable 120a to spiral inwards to form the cable spiral 120c.

FIG. 8b shows the situation of the electrical power cable 120a, when a maximum twist angle is attained when cable spiral 120c is tightly wound around the centre point of rotation. The yaw actuator system 18 is configured to control the ground control unit 1 yaw angle back to a working range in order to avoid damaging the power cable 120a.

FIGS. 9a-9d show exemplary embodiments of various steps for a fully automated retrieval of the kite 20 towards the ground control unit 1 using the launch and retrieval system as described with reference to FIG. 6. In general wordings, the ground control unit 1 is arranged to control the winch pulleys 32, 33 and the launch and retrieve system 126-129 synchronously for launch or retrieval of the kite 20. The retrieve operation of the kite 20 is performed by a combination of moving out the launch and retrieve support frame 128 towards the incoming kite 20 and reeling-in the traction cables 10, 11 to such extend that the bridle cables 6 of the kite 20 are pulled through the guide aperture 129 in the kite support frame 128 and capture/fold both kite bridle lines 6 and kite airfoil material 20 tightly to the kite support frame 128.

In an alternative embodiment, the kite support frame 128 is positioned perpendicular between the traction cables 10,11 to support the incoming kite 20 around the bottom middle line of the kite 20 during launch and retrieve operation. In this case the retrieve operation of the kite 20 is performed by a combination of moving out the launch and retrieve support frame 128 towards the incoming kite 20 and reeling-in the traction cables 10, 11 to such extend that the kite airfoil is supported by the support frame around the bottom middle line of the kite and then is pulled tightly around the support frame while further reeling-in the traction cables 10, 11.

In an even further alternative embodiment (see also FIG. 3b), the telescopic arm 127 and launch and retrieve support frame 128 (with guide apertures 129) can extend independently from each other, and the telescopic arm 127 may be provided with an additional flange for support of the kite 20. The additional flange of the telescopic arm 127 can extend beyond the plane of the launch and retrieve support frame 128, allowing to push out the kite 20 from the launch and retrieve support frame 128 during launch. During retrieval, the extending telescopic arm 127 can then be used to catch the kite 20 first and wrap it against the telescopic arm 127.

FIG. 9a shows the configuration of the ground control unit 1 with the telescopic arm 127 fully extended, as a first step of retrieving the kite 20. In this embodiment the cable winch pulleys 32, 33 are controlled to spool the traction cables 10, 11 onto the cable winch pulleys 32, 33 up to a point where the traction cable guide 29 arrives at the opening 129 of the support frame 128.

FIG. 9b shows the configuration in a further step, where bridle lines 6 are being pulled through the support opening 129 by the traction cables 10,11. The support opening 129 is configured (e.g. with smooth edges) to fold the bridle lines 6 together. Similarly, the kite airfoil material is also folded together due to the compression of the bridle lines 6 by the support opening 129.

FIG. 9c shows the configuration in the following step, wherein the bridle lines 6 are fully folded together by the support opening 129, and pulling the folded kite airfoil material against the support frame 128. In this embodiment a locking or clamping mechanism 130 is used to clamp the collected bridle lines 6 to the support frame 128. The locking mechanism 130 keeps the kite airfoil material pulled against the support frame 128 when the telescopic arm 127 is being retracted and the traction cables 10, 11 loose tension.

FIG. 9d shows the configuration of a fully retracted telescopic arm 127 back in a parking position, carrying the support frame 128 with the folded bridle lines 6 and a deflated kite 20. The captured bridle lines 6 and kite airfoil material 20 can now be stored at ground level. The kite 20 and its components are now retracted in an orderly fashion, which allows easy and controllable subsequent launch of the kite 20.

FIGS. 10a-10d show configurations associated with various steps for a fully automated launch of the kite 20. In general wordings, the launch operation of the kite 20 is performed by a combination of moving out the launch and retrieve support frame 128, unlocking the clamping mechanism 130 and reeling-out the traction cables 10, 11 including the bridle cables 6 of the kite 20 thus slowly releasing and unfolding the kite bridle line(s) 6 and kite airfoil material 20 through the guide apertures 129 in the support frame 128.

FIG. 10a shows a configuration following the fully retracted configuration of FIG. 9d. The telescopic arm 127 extends the support frame 128 from the parking position to a launch position. In this position the locking mechanism 130 of the support frame 128 is released.

FIG. 10b shows the configuration where the (airfoil) kite 20 is inflated by slowly unspooling the traction cables 10, 11 combined with ambient wind. It is noted that the support frame 128 has sufficient open surface to let through the wind, yet is also sufficiently strong to act as support for the non-inflated kite 20.

Additionally or alternatively, forced air from an air flow generator such as an (electric) fan 131 may be used to fill the kite 5 through its air inlets in the leading edge. The fan 131 blows air in the direction of the kite 20 thus filling the kite airfoil through the ram air filling inlets, and thus supports unfolding of the kite 20 and support the release of the kite 5 from the support frame 128 into the air until the wind takes over. The electric fan 131 may be positioned close to or integrated with the ground control unit 1. The electric fan 131 may also be used to provide cooling air to the generator 30 during operation.

FIG. 10c shows the configuration with a fully unfolded/inflated airborne kite 20, wherein the unfolded bridle lines 6 and the traction cable guide 29 have passed through the support opening 129 of the support frame 128.

FIG. 10d then shows the configuration where the telescopic arm 127 is once again retracted entirely and holds the support frame 128 in the parking position. The power generating kite system is now fully operational for harvesting wind energy.

It is noted that the yaw actuator system 18 is also useable during the launch and retrieve phases, for keeping the ground control unit 1 aligned with the ambient wind direction, to allow a controlled and efficient launch or retrieval of the kite 20.

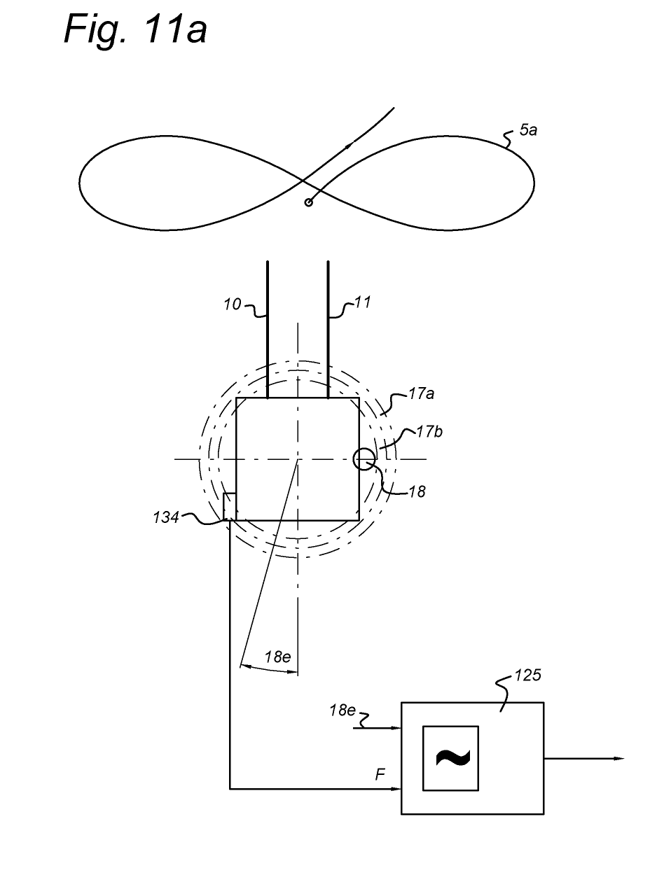

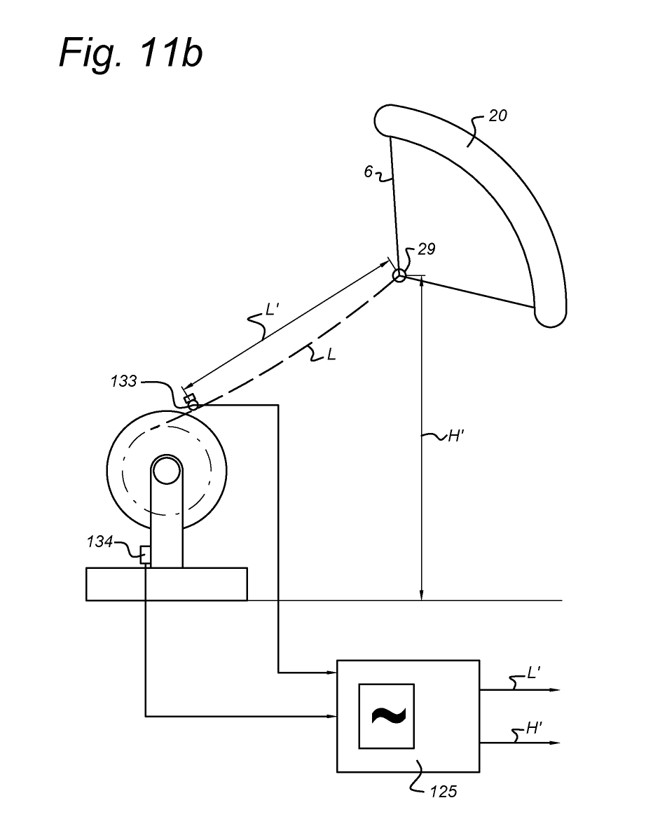

FIG. 11a shows an embodiment of a processing unit 125 forming or being part of the control electronics 125 of the ground control unit 1. In this embodiment, the control electronics 125 are arranged to determine an (average) wind direction using the yaw angle 18e and the traction force in the main traction cables 10, 11 (from a force sensor 124). The yaw angle 18e can be measured using an angular sensor (not shown) or may be derived from the yaw actuator system 18. The resulting control signal representing the wind direction can then be used as a control signal, e.g. to control the kite trajectory 20 using the actuator system 35-37 to control relative position of the cable winch pulleys 32, 33. In a specific embodiment, the ground control unit 1 comprises a processing unit 125 connected to a force sensor 134 measuring the force exerted on the ground control unit 1 by the main traction cables 10, 11, and an azimuth position sensor for measuring the relative azimuth angle (18e). The wind direction information is then determined by analyzing the traction cable force information in relation to yaw angle to eliminate the need for a separate wind direction sensor.

FIG. 11b shows a further embodiment of a processing unit 125 forming or being part of the control electronics 125 of the ground control unit 1. In this embodiment, altitude information of the kite 20 is determined with a calculation model, using as inputs the free length L of the traction cables 10,11, the elevation angle of the traction cables 10, 11 (both determined by a combined sensor 133), and the traction force in the main traction cables 10, 11. The free length L and elevation angle are measured by a combined angle and cable length sensor 133 and the traction cable force is measured by 10 the force sensor 134. In a specific embodiment, the processing unit 125 is connected to a cable length sensor 133, a traction cable elevation angle sensor 133, and to a force sensor 134 measuring the force exerted on the ground control unit 1 by the main traction cables for determining the altitude of the kite. This embodiment, in combination with the embodiment shown in FIG. 11a could avoid the use of a GPS sensor and need for a remote data link to the kite 20 as is used in prior art kite power systems.

The embodiments described with reference to FIGS. 11a and 11b can of course be combined or augmented with further sensors or control algorithms.

The present invention embodiments have been described above with reference to a number of exemplary embodiments as shown in the drawings. Modifications and alternative implementations of some parts or elements are possible, and are included in the scope of protection as defined in the appended claims.

1-39. (canceled)

40. A kite power system comprising
a ground control unit with a generator, and a kite connected to the generator via at least two main traction cables,
wherein a rotor part of the generator comprises a winch pulley for each of the at least two main traction cables, and
wherein each of the winch pulleys is indirectly mechanically connected to the generator.

41. The kite power system of claim 40,
wherein each of the winch pulleys is rotatably connected to the rotor part, and are mutually connected by means of a differential gear, the differential gear having a housing and output axes, the housing being connected to the rotor part and the output axes being connected to the respective winch pulleys.

42. The kite power system of claim 41,
wherein a relative rotational position of the winch pulleys relative to the rotor part can be set by means of a setting unit having a hydraulic or electric powered actuator, the hydraulic or electric powered actuator being positioned between the rotor part and one of the output axes connected to the winch pulleys, or between the rotor part and one of a plurality of satellite wheels in the differential gear.

43. The kite power system of claim 41,
wherein a relative rotational position of the winch pulleys relative to the rotor part can be set by a braking action on one of the winch pulleys, or on a drive shaft connected thereto, using a braking unit with a hydraulic or electric powered actuator.

44. The kite power system of claim 40, wherein the winch pulleys are positioned co-axial and are provided with a setting unit for adjusting a relative rotational position of the two winch pulleys.

45. The kite power system of claim 40, wherein the generator is a direct drive generator.

46. The kite power system of claim 40, wherein one of the winch pulleys is fixedly attached to the rotor part, and the other ones of the winch pulleys are attached to the rotor part in a rotatable manner.

47. The kite power system of claim 44, wherein the setting unit is operational in a first range of relative rotational positions during a first condition, and is operational in a second range of relative rotational positions during a second condition.

48. The kite power system of claim 47, wherein the setting unit comprises a hydraulically or electrically powered actuator, and is arranged to control a flight trajectory of the kite in the first condition, and to rewind the at least two main traction cables in the second condition.

49. The kite power system of claim 40, wherein the generator comprises a rotor part and a stator part, wherein the rotor part and/or stator part comprise laminated components, the laminated components forming a torque transferring housing and active material.

50. The kite power system of claim 49, wherein the laminated components are provided with cooling fins.

51. The kite power system of claim 40, further comprising a kite, the kite comprising an airfoil shaped body with one or more air filling apertures in a leading edge part of the airfoil shaped body,
and at least two main traction cables connected to the airfoil shaped body,
further comprising an additional filling aperture in a side part of the airfoil shaped body.

52. The kite power system of claim 51, wherein the one or more air filling apertures and the additional filling aperture are provided with one-way valves.

53. The kite power system of claim 51, wherein the kite further comprises a bridle system connecting a plurality of points on the airfoil shaped body to the at least two traction cables, wherein the bridle system provides an airfoil shape to the airfoil shaped body in a first condition, and an air filled airfoil shaped body with a low drag profile in a second condition.

54. The kite power system of claim 53, wherein the bridle system comprises a first part and a second part,
the first part being connected to one half of the airfoil shaped body and comprising a first cable guide, and the second part being connected to the other half or the airfoil shaped body and comprising a second cable guide,
the first and second cable guide guiding a first cable connected to the airfoil shaped body at both ends of the first cable, and the cable guide being connected to a point on the airfoil shaped body using a second cable.

55. The kite power system of claim 53, wherein the low drag profile is a curved form of the airfoil shaped body.

56. The kite power system of claim 51, wherein the kite further comprises a traction cable guide holding the at least two main traction cables at a fixed distance from each other.

57. The kite power system of claim 51, wherein the kite further comprises a deployable fin on the side of the kite opposite to the attachment of the second main traction cable, the deployable fin being arranged to be extended during a rewinding phase.

58. The kite power system of claim 51, wherein the kite further comprises sensor electronics.

59. The kite power system of claim 51, wherein the kite further comprises an identification unit.

60. The kite power system of claim 51, further comprising one or more cable guides having a locking mechanism operable on one of the main traction cables.

61. The kite power system of claim 40, wherein the winch pulleys are positioned co-axial, and wherein the ground control unit further comprises a yaw actuator system for controlling a relative azimuth angle of the ground control unit with respect to the at least two main traction cables during operation.

62. The kite power system of claim 61, wherein the generator of the ground control unit is connectable to a power conversion system external to the ground control unit, and the ground control unit is rotatable in an azimuth range of more than 360°.

63. The kite power system of claim 62, comprising an electrical power cable with a twisted part, connected to the generator.

64. The kite power system of claim 62, comprising a slip ring assembly for electrical connection to the generator.

65. The kite power system of claim 61, wherein the ground control unit further comprises a cable guide mechanism for axially positioning the at least two main traction cables with respect to the associated winch pulley.

66. The kite power system of claim 65, wherein the ground control unit is arranged to control the cable guide mechanism to position the main traction cables with respect to the winch pulleys, and to control the yaw actuator system in a free mode of operation.

67. The kite power system of claim 61, wherein the generator comprises a rotor part and a stator part, and an electrical connection to the rotor part is provided by a rotor slip ring assembly.

68. The kite power system of claim 61, wherein the ground control unit comprises a processing unit connected to a force sensor measuring the force exerted on the ground control unit by the main traction cables, and an azimuth position sensor for measuring the relative azimuth angle.

69. The kite power system of claim 61, wherein the ground control unit comprises a processing unit connected to a cable length sensor, a traction cable elevation angle sensor, and to a force sensor measuring the force exerted on the ground control unit by the main traction cables for determining the altitude of the kite.

70. The kite power system of claim 61,
the ground control unit further comprising a launch and retrieve system connected to the generator.

71. The kite power system of claim 70, wherein the launch and retrieve system is rotatable over an elevation angle.

72. The kite power system of claim 70, wherein the launch and retrieve system comprises a telescopic arm carrying a kite support frame provided with a guide aperture for each of the main traction cables.

73. The kite power system of claim 72, wherein the kite support frame is moveable by the telescopic arm in an extended position or in a retracted position.

74. The kite power system of claim 72, wherein the ground control unit is arranged to control the winch pulleys and the telescopic arm synchronously for launch or retrieval of the kite.

75. The kite power system of claim 72, wherein the launch and retrieval system comprise a clamping mechanism for capturing kite bridle line(s) and kite airfoil material to the support frame.

76. The kite power system of claim 70, wherein the launch and retrieve system comprises a telescopic arm having a kite support frame arranged to pull and fold the bottom side of the kite against a centre line thereof during retraction of the main traction cables.

77. The kite power system of claim 76, wherein the kite support frame comprises and additional support frame arranged to pull and fold the bottom side of the kite against a centre line thereof during retraction of the main traction cables.

78. The kite power system of claim 70, wherein the launch and retrieval system comprises an air flow generator.
